(19) United States
(12) Patent Application Publication
(10) Pub. No.: US 2015/0181915 A1
(43) Pub. Date: Jul. 2, 2015

(54) Change Control Dietary System

(71) Applicant: Harry Suiter, Washington, NJ (US)

(72) Inventor: Harry Suiter, Washington, NJ (US)

(21) Appl. No.: 14/145,109

(22) Filed: Dec. 31, 2013

(51) Int. Cl. A23L 1/29

(52) U.S. Cl. CPC A23L 1/293

(57) ABSTRACT

A dietary and exercise program provides a step-wise transition from unhealthy dietary/exercise patterns to healthy patterns in a controlled manner, so as to allow the dieter's body to adjust to the changes without experiencing strong cravings, stress and/or fatigue. The program comprises three integrated components: (1) a progressive food choice component, (2) a step-wise, transitional caloric intake component and (3) a progressive exercise component. The food choice component progresses through multiple levels in which an increasing proportion of the diet consists of healthy meals, until a target food choice level is reached or the dieter attains his/her target weight. During the first food choice level, the dieter makes a gradual transition from his/her baseline caloric intake to that recommended by the NIH based on age, gender and activity level.

### FIELD OF INVENTION

The present invention relates to the field of methods for achieving and maintaining a healthy diet and a healthy weight. More particularly, the present invention is a dietary and exercise process which provides a step-wise transition from unhealthy dietary/exercise patterns to healthy patterns in a controlled manner, so as to allow the dieter's body to adjust to the changes without experiencing strange cravings, stress and/or fatigue.

### BACKGROUND OF THE INVENTION

Over the past few decades, weight loss programs have spawned a huge industry projected to generate sales of almost $42 billion in the United States by the year 2017. Yet, judging by the results, existing weight loss programs are dismal failures. Worldwide obesity has almost doubled since 1980, while obesity in the U.S. has risen by about 50% in the last 20 years. America has attained the unenviable status of the world's heaviest nation, with approximately 68% of adults overweight and almost 36% obese.

Estimated annual medical costs associated with obesity amounted to $147 billion in 2008, due to obesity-related conditions including heart disease, stroke, type-2 diabetes, and certain types of cancer. Obesity is in fact a disease that has reached epidemic proportions. And yet, it is a preventable disease. Why then is it not being effectively treated?

Existing dietary and exercise programs fail because they offer a “quick fix,” which is attractive for marketing purposes but at best yields only temporary results. An overweight adult at 40 years of age has spent four decades training his/her body to make the wrong choices in terms of food and activity. The inconvenient truth is that these ingrained life-long behavioral patterns cannot be suddenly reversed in a matter of a weeks or even months. Expecting a person suddenly to go from a “couch-potato” consuming over 4000 daily calories laced with junk foods to an active lifestyle at under 2000 healthy calories per day is like expecting them to train to run a marathon in a few days. The pre-ordained result is failure.

Consequently, existing weight loss programs induce a pathological pattern of raised expectations followed by abject failure and despondency, which finds false solace in yet more over-eating and further weight gain. Is it really any wonder, then, that worldwide obesity is sky-rocketing?

In order to break this pattern of failure and despair, what is needed is a realistic dietary modification process—one which accommodates the body's need for time to adjust to changes in caloric intake, food choices and activity levels.

### SUMMARY OF THE INVENTION

The present invention is a step-wise dietary change control program for sustainably modifying the caloric intake, dietary content and exercise habits of an individual. The program comprises three integrated components: (1) a progressive food choice component, (2) a step-wise, transitional caloric intake component and (3) a progressive exercise component.

The food choice component comprises multiple weekly dietary change levels, based on weekly dietary change proportions of “choice” meals and snacks to “healthy” meals and snacks. A “choice” meal/snack consists of whatever the individual chooses to consume, provided it complies with the caloric intake component. A “healthy” meal/snack consists of lowfat proteins (such as chicken, turkey, fish, eggwhites, beans or tofu), fresh vegetables, fresh fruits, raw nuts, and whole grains (including brown rice, whole-grain cereals and whole-grain pasta).

Each dietary change level is based on the individual eating three meals and three snacks per day, respectively consisting of breakfast, lunch and dinner meals and mid-morning, mid-afternoon and evening snacks. This equates to a weekly total of 21 meals and 21 snacks. At the first dietary change level, the dietary change proportion is at a minimum value, such that the number of weekly healthy meals and snacks starts at a lowest baseline number. At each subsequently higher dietary change level, the dietary change proportion increases incrementally, such that the number of weekly healthy meals and snacks increases step-wise as the individual advances to progressively higher dietary change levels.

By way of illustration of the weekly dietary change levels, Table 1 displays a seven level program wherein the number of weekly healthy meals and snacks increases incrementally from two each at Level 1 to fourteen each at Level 7. Contrariwise, the number of weekly choice or “real” meals and snacks decreases decrementally from nineteen each at Level 1 to seven each at Level 7.

Change Control Diet Food Level Guidelines

| | % Change in | Per Week | Per Week | Per Week | Per Week |
|---|---|---|---|---|---|
| | Food Choices | Real | Healthy | Real | Healthy |
| Level | from Start | Meals | Meals | Snacks | Snacks |
| 1 | 9.5 | 19 | 2 | 19 | 2 |
| 2 | 19.0 | 17 | 4 | 17 | 4 |
| 3 | 28.5 | 15 | 6 | 15 | 6 |
| 4 | 38.0 | 13 | 8 | 13 | 8 |
| 5 | 47.5 | 11 | 10 | 11 | 10 |
| 6 | 57.0 | 9 | 12 | 9 | 12 |
| 7 | 66.5 | 7 | 14 | 7 | 14 |

The caloric intake component of the program coincides with the first dietary change level of the food choice component. It comprises a staged series of decremental caloric adjustments, beginning at a baseline average daily caloric intake, which is the average number of calories that the individual is consuming daily at the beginning of the program. The caloric adjustments are applied to define a decreasing series of adjusted average daily caloric intakes corresponding to successive stages. In the first stage of the caloric intake component, the baseline average daily caloric intake is reduced by a first stage adjustment to define a first adjusted average daily caloric intake. In the second stage, the first adjusted average daily caloric intake is reduced by a second stage adjustment to define a second adjusted average daily caloric intake. This process of successive decremental caloric adjustments is continued until a target average daily caloric intake is achieved. A typical target average daily caloric intake would be that recommended by the National Institute of Health (NIH), based on age, gender and activity level.

By way of illustration, Table 2 displays exemplary staged decremental caloric adjustments, starting from baseline average daily caloric intakes ranging from 30,000 to 3,000 and resulting in the target average daily caloric intake of approximately 2000.

| Current | | | | | | Total Adjustments |
|---|---|---|---|---|---|---|
| Daily | First | Second | Third | Fourth | Fifth | to reach ~2000 |
| Calories | Adjustment | Adjustment | Adjustment | Adjustment | Adjustment | Calories per day. |
| 30,000 | 27,000 | 24,300 | 21,870 | 19,683 | 17,715 | 26 |
| 25,000 | 22,500 | 20,250 | 18,225 | 16,403 | 14,762 | 24 |
| 20,000 | 18,000 | 16,200 | 14,580 | 13,122 | 11,810 | 22 |
| 15,000 | 13,500 | 12,150 | 10,935 | 9,842 | 8,857 | 19 |
| 10,000 | 9,000 | 8,100 | 7,290 | 6,561 | 5,905 | 15 |
| 5,000 | 4,500 | 4,050 | 3,645 | 3,281 | 2,952 | 9 |
| 4,000 | 3,600 | 3,240 | 2,916 | 2,624 | 2,362 | 7 |
| 3,000 | 2,700 | 2,430 | 2,187 | 1,968 | NA | 4 |

The caloric intake component of the program distributes the adjusted average daily caloric intakes between daily meals and snacks, with 75% of the daily calories allocated to meals and 25% allocated to snacks. Optimally, not more than 5% of the daily caloric intake is allocated to the evening snack.

In the caloric intake component of the program, the individual spends a minimum of seven days at each stage of the decreasing adjusted average daily caloric intakes. The individual progresses from a lower stage of caloric adjustment to a next higher stage when he/she has met the stage success criterion, defined as staying within the daily caloric intake for the lower stage for at least six out of the seven days.

Once the target average daily caloric intake is achieved, the individual advances progressively through the dietary change levels of the food choice component of the program, spending at least seven days at each level. Progress from a lower dietary change level to a next higher dietary change level is based on three change success criteria: (1) consuming the number of healthy meals and healthy snacks required at the lower level for all seven days, (2) eating six times a day—three meals and three snacks—at least six of the seven days, and (3) staying within the target average daily caloric intake for at least six of the seven days.

The exercise component of the program comprises multiple levels of progressively more frequent, longer and more intense exercise sessions. A minimum of one week is spent at each level, with progress from a lower level to a next higher level based on the exercise success criterion defined by performing all requirements of the lower level for one full week. An exemplary exercise component comprising five levels is illustrated in Table 3.

Change Control Diet Exercise Guidelines

| | Exercise Sessions | Positive Thinking |
|---|---|---|
| Level | Per Week | Daily |
| 1 | 2 Times Low Intensity | 5 Minutes AM |
| | 30 Minutes | |
| 2 | 3 Times Low Intensity | 5 Minutes AM |
| | 30 Minutes | |
| 3 | 3 Times Moderate Intensity | 5 Minutes AM |
| | 30 Minutes | |
| 4 | 3 Times Moderate Intensity | 5 Minutes AM |
| | 45 Minutes | |
| 5 | 3 Times High Intensity | 5 Minutes AM |
| | 60 Minutes | |

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a flowchart for the food choice component and the caloric intake component of the dietary change control program according to one embodiment of the present invention; and

FIG. 2 is a flowchart for the exercise component of the dietary change control program according to one embodiment of the present invention.

### DETAILED DESCRIPTION OF THE PREFERRED EMBODIMENT

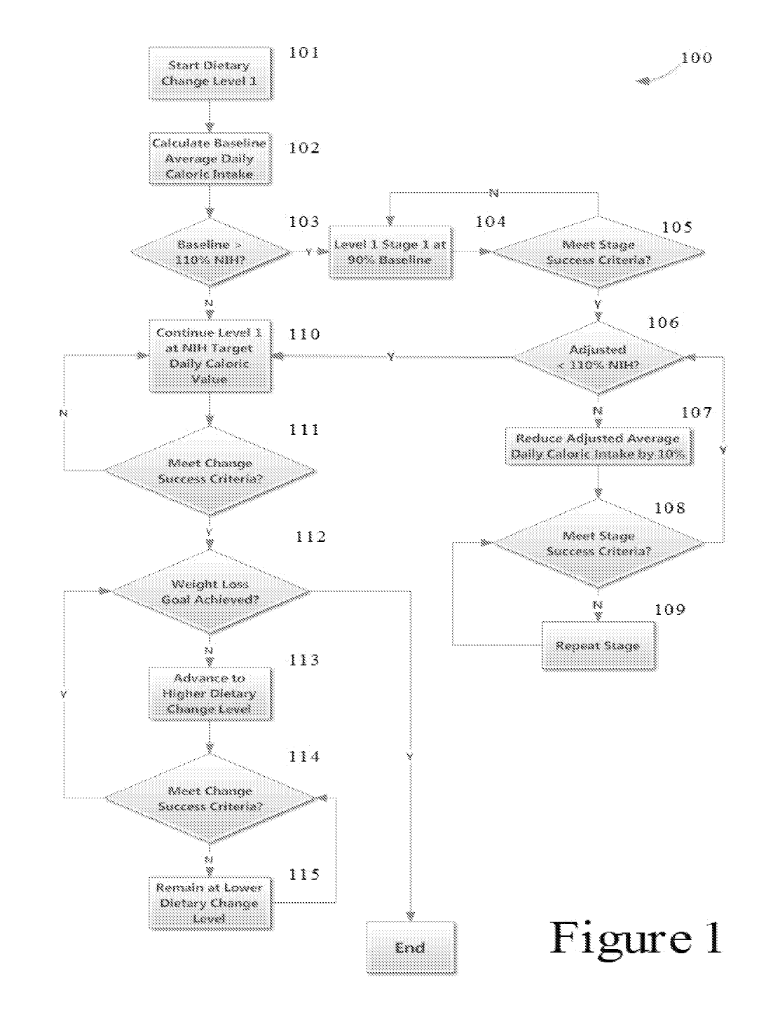

FIG. 1 is a flowchart illustrating the integrated implementation of the food choice and caloric intake components of an exemplary dietary change control program 100. For illustrative purposes, this process implements the seven dietary change levels described in Table 1.

Starting with Dietary Change Level 1 101, the individual has a total of 21 meals and 21 snacks per week, of which 2 meals and 2 snacks are in the “healthy” category, while 19 meals and 19 snacks are left to free choice. Calories are distributed 75% to meals and 25% to snacks.

The dieter begins by calculating his/her baseline average daily caloric intake at the outset of the program 102 and then comparing this baseline with the daily average caloric intake recommended by the NIH for his/her age, gender and activity level 103. If the baseline is greater than 110% of the NIH value, the individual begins Dietary Change Level 1 with a Stage 1 average daily caloric intake equal to 90% of the baseline 104.

If, for example, the dieter is a 40-year-old, moderately active female, the recommended NIH average daily caloric intake is 2,000 calories. If she begins the program at a baseline average daily caloric intake of 4,000 calories, her first adjusted average daily caloric intake will be 3,600 calories, as shown in Table 2. She will remain at the first stage at least one week until she has met the stage success criteria for advancing to the next stage—which consists of staying within the first adjusted daily caloric intake of 3,600 calories for at least six of seven days of the week 105.

When she has met the first stage success criteria, the dieter advances to stage two, in which first adjusted average daily caloric intake is reduced by another 10% to define the second adjusted average daily caloric intake of 3,240 calories 106. She remains at stage two until she again meets the stage success criteria 108, at which point the second adjusted average daily caloric intake is in turn reduced by 10% to define a third adjusted average daily caloric intake of 2,916 calories 107. As shown in Table 2, this decremental caloric adjustment process continues through fourth, fifth, sixth, and seventh adjusted average daily caloric intakes, at which point the caloric intake is less than 110% of the NIH value 106, and the dieter continues in Dietary Change Level 1 at the NIH recommended average daily value of 2,000 calories 110.

Progress in the program now shifts from the caloric intake component to the food choice component. The dieter remains at Dietary Change Level 1 for at least a week, until she has met the three change success criteria: (1) consuming the number of healthy meals and healthy snacks required at the lower level for all seven days, (2) eating six times a day—three meals and three snacks—at least six of the seven days, and (3) staying within the target caloric intake for at least six of the seven days.

Upon meeting the change success criteria 111, the dieter advances to the next higher Dietary Change Level 113, in this case Level 2. As shown in Table 1, her healthy meals and healthy snacks each increase to four per week, while weekly choice meals and snacks each decrease to seventeen. By satisfying the change success criteria 114 at each Dietary Change Level, the dieter continues to advance to the next higher level 113 until either attaining the highest level (in this example Level 7) or achieving her weight loss goal 112. In this example, if she reaches Level 7 before achieving her weight loss goal, she will continue to have 14 healthy meals and 14 healthy snacks per week until her weight goal is attained.

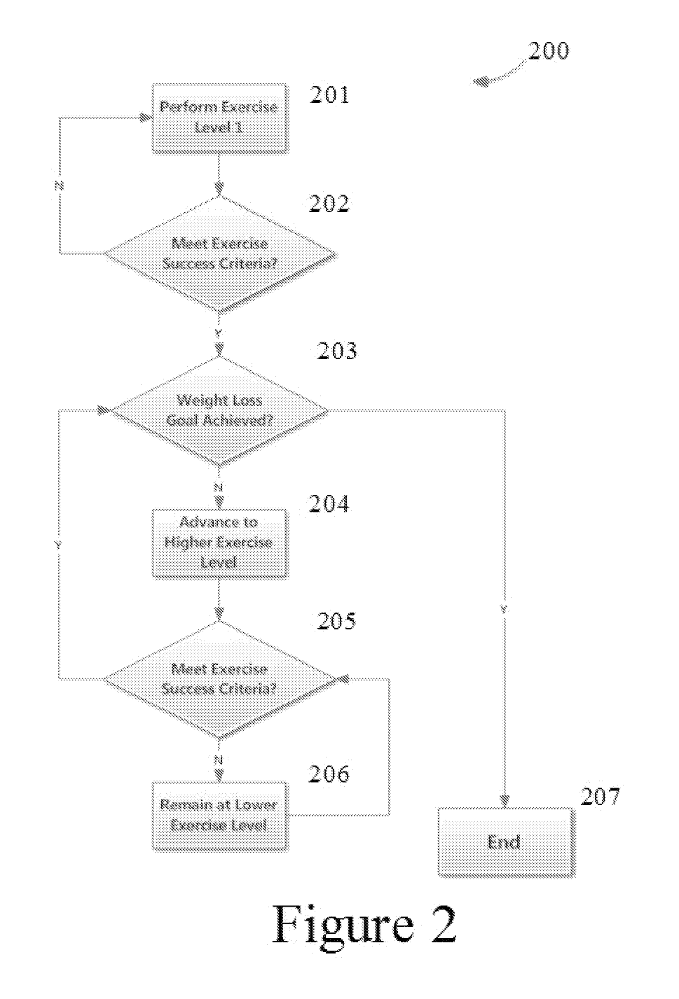

Referring to FIG. 2, the exercise component of this program is implemented concurrently with, but independently of the food choice and caloric intake components. For illustrative purposes, the dieter progresses through the five Exercise Levels described in Table 3, beginning with Level 1 201. At Exercise Level 1, she will have two 30-minute low-intensity exercise sessions per week. When she has strictly adhered to the Level 1 regimen for one full week, she meets the exercise success criteria 202 and advances to the next higher Exercise Level 204, in this case Level 2.

The individual continues to advance through successively higher Exercise Levels by satisfying the exercise success criteria 205 until she has either attained the highest level (in this case, Level 5) or achieved her weight loss goal 203. In this example, if she reaches Level 5 before achieving her weight loss goal, she will continue to do three 60-minute high-intensity exercise sessions per week until her weight goal is attained.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A method by which an individual progressively modifies his/her diet and activity, comprising the following steps:
(a) consuming three meals and three snacks per day, so as to consume 21 weekly meals and 21 weekly snacks;
(b) selecting the weekly meals and the weekly snacks according to multiple weekly dietary change levels, which begin at a first dietary change level and progress from lower dietary change levels through higher dietary change levels to a target dietary change level, wherein each dietary change level specifies a dietary change proportion of healthy foods to choice foods, and wherein the dietary change proportion becomes progressively greater as the individual advances, in multiple incremental steps of one dietary change level, from the lower dietary change levels to the higher dietary change levels;
(c) in the first dietary change level, implementing a staged series of decremental caloric adjustments, beginning at a baseline average daily caloric intake of the individual and advancing through one or more stages of decrementally adjusted average daily caloric intakes until the adjusted average daily caloric is not greater than a target average daily caloric intake, wherein the individual advances between stages, from a lower stage to a next higher stage, upon fulfilling one or more stage success criteria; and
(d) progressively advancing from the first dietary change level to the target dietary change level, wherein each incremental step from a lower dietary change level to a next higher dietary change level is taken upon the individual fulfilling one or more change success criteria.

2. The method of claim 1, wherein the target average daily caloric intake is equal to an average daily caloric intake recommended by the National Institute of Health based on the individual's age, gender and activity level.

3. The method of claim 2, wherein the stage success criterion consists of not exceeding the adjusted average daily caloric intake for the stage for six of seven successive days.

4. The method of claim 3, wherein the change success criteria consist of: (i) consuming a number of healthy meals and healthy snacks consistent with the dietary change proportion for the lower dietary change level for seven successive days, and (2) consuming three meals and three snacks per day for at least six of the seven successive days, and (3) not exceeding the target average daily caloric intake for at least six of the seven successive days.

5. The method of claim 4, comprising the additional step of undertaking a progressive exercise regimen, comprising multiple activity levels that define activity requirements of progressively more frequent, longer and more intense exercise sessions, wherein a minimum of one week is spent at each activity level, with progress from a lower activity level to a next higher activity level predicated on one or more exercise success criteria.

6. The method of claim 5, wherein the exercise success criterion consists of fulfilling the activity requirements of the lower activity level for at least one full week.

7. The method of any one of claims 1-6, comprising the additional step of the individual selecting a target weight and defining the target dietary change level as the dietary change level at which the individual attains the target weight.

8. The method of claim 7, comprising the additional step of providing an application software which controls the operation of a computer device so that the device tracks the individual's progress through the dietary change levels, the stages of adjusted daily caloric intakes, and the activity levels, and so that the device determines when the individual has fulfilled the stage success criteria, the change success criteria, and the exercise success criteria.
